(19) United States
(12) Patent Application Publication
(10) Pub. No.: US 2004/0036424 A1
(43) Pub. Date: Feb. 26, 2004

(54) Drive control device for mixing and changing of light colors of light-emitting member

(76) Inventor: Johnny Hsieh, Taipei (TW)

Correspondence Address: TROXELL LAW OFFICE PLLC, SUITE 1404, 5205 LEESBURG PIKE, FALLS CHURCH, VA, 22041, US

(21) Appl. No.: 10/223,357

(22) Filed: Aug. 20, 2002

(51) Int. Cl. H05B 37/02

(52) U.S. Cl. 315/291; 315/200 A

(57) ABSTRACT

A drive control device for mixing and changing of light colors of light-emitting member, in the casing unit of the drive control device is installed a driver circuit, connected to at least a three light coupler type Led member, in combination with a switch member for sequential pressing and selection, so when one module in a different color mixture of module is activated, it drives the light coupler member of three different light colors in the three light coupler type Led member, and the selected one activates one or more for simultaneous light emission, forming a mixture of light waves and spectrum to emit different colors of light, to serve as alarm or decorative items on various commodities, to have the effects of consumer's spontaneous selection and control of changing colors of and changing lights.

### BACKGROUND OF THE INVENTION

The conventional LED (Light Emitting Diodes) member, because of its installation of a single-color light coupler member inside, can only be used for single-color lighting purposes, and mostly used for detection of electronic condition display, further it is arranged in quantities and adopted for display of information and characters for alarm or lamp display, or decorative purposes. But the single-color LED member is too monotonous to meet modern demand for variation and innovation. Therefore, there has been the introduction of three light coupler type LED member with the installation of three different color light coupler members in a single LED member, including red (R), green (G) and blue (B). By activating and setting respectively one of the red (R), green (G) or blue (B) light coupler members, the three light coupler type Led member can respectively emit red (R), green (G) and blue (B) colors of light, and with arrangement and combination of three different light colors, producing variable eye-catching effects serving as display, alarm or decorative purposes. But in that kind of structural design, the LED member can only be controlled to change three different colors, unless a structural change is made on the colors of the light coupler members in the LED member. That change is inconvenient, labor and cost consuming, and even after changing the combination of different light colors in the light coupler member, the one producing the three light colors still exists, and could not obtain the emission of more changing colors.

### SUMMARY OF THE INVENTION

The invention of drive control device for mixing and changing of light colors of light-emitting member can be programmed or set by the various drive modules of the drive processor (IC component) of the original drive setting, by optionally pressing the switch member for optional light colors according to module setting, to separately activate the red (R), green (G) or blue (B) color coupler members in the three light coupler type LED member, or simultaneously activate two or more of them to emit light, which is naturally blended by light wave spectrum to create different colors, to obtain consumer's spontaneous control of the light-emitting member to create color changes.

### BRIEF DESCRIPTION OF DRAWINGS

FIG. 1 is a perspective view of a preferred embodiment of the invention.

FIG. 2 is a wiring diagram of the driver circuit of the invention.

### DETAILED DESCRIPTION OF PREFERRED EMBODIMENTS

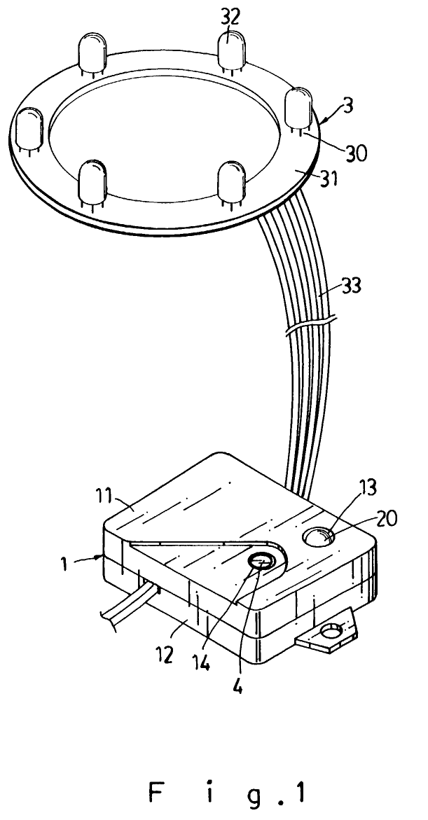

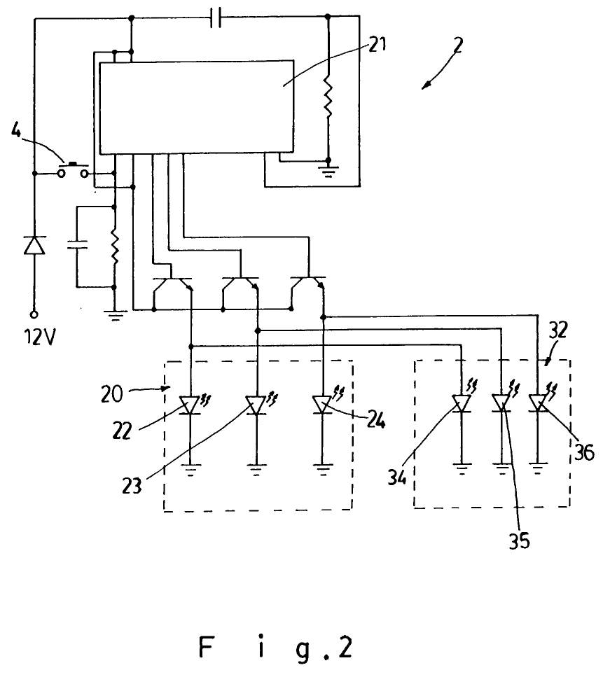

Please refer to FIGS. 1 and 2 that illustrate a preferred embodiment of the invention by citing a connection serving as an alarm and decorative lighting fixture. As shown in the drawing, the invention comprises a casing unit 1, fitted with at least one set of driver circuit 2 that is driven by a switch member 4, and at least one set of electrically connected light-emitting member carrier 3, as shown in FIG. 1, wherein:

The casing unit 1 consists of two pairs of hemispheric casings 11, 12 that are matching and combined with each other (by way of snapping, gluing or screw tightening), in various configuration and specifications. Inside the casing unit 1 is an accommodating space to install at least one set of driver circuit 2. On its end face is at least one opening 13, for installation of the switch member 4 of the electrically connected driver circuit 2, to facilitate pressing control. On another end face of the casing unit 1 is further an opening 14 to suit actual requirement or design, for installation of a light-emitting member 20 for optional light display installed in the driver circuit 2, to obtain the acknowledgement and verification of the chosen colors when pressing the switch member 4.

At least one set of light-emitting member carrier 3, on an end face of the carrier 31, there is at least one LED member 32 to suit actual requirement or design, the electrically connected LED members 32 being connected to a conductive wire 33 and the driver circuit 2 inside the casing unit 1, waiting to be activated to emit light.

The aforementioned carrier 31 can be made to suit requirement or design in various shapes and specifications, providing at least one member carrier zone 30, for the arrangement of electronic member and LED member 32; the LED member 32 is made of three optical-coupler type LED members in the preferred embodiment of the invention, but not limited thereto. The LED member of this type relates to a single LED member consisting of three different colors of light coupler member 34, 35, 36 (shown in FIG. 2), red (R), green (G) and blue (B), each different color of light coupler member is respectively activated to produce specified light color. Of course, if there are three or more colors of light coupler members of LED light-emitting member units, they can be adopted by this invention.

At least one set of driver circuit 2, comprising a drive processor (IC component) 21, in this preferred embodiment, we use an IC component of model number C9239ME, but the type of driver processor (IC component) used in this invention is not limited thereto. An electrically connected 12V power supply provides power for operation. The driver processor (IC component) 21 can be written by a designed program, or other setting (such as the originally designed operation of the processor (IC component)), to set various items of driver modules, so that each light coupler member of the LED member 32 can be activated to emit light and programmed in modules, forming various driving module settings of respective original colors and mixtures of light colors, this setting of various driver modules can be selected by pressing in sequence a switch member 4 that is electrically connected to the driver processor (IC component) 21. As for the driver activating connector pins of the driver processor (IC component) 21, they are respectively connected electrically to the optical coupler member 34, 35, 36 of the light colors red (R), green (G) and blue (B) of the three light coupler Led members 32.

To enable direct acquisition of the light colors emitted by the driver module options, without actual observation of the operation of the light-emitting member carrier 3 when each switch member 4 is pressed to select operating light colors, the light emitting member carrier 3 can be installed by connection of the conductive wire to a farther position, and may be designed as required to install a light-emitting member 20 for selection of light color display in the driver circuit 2. This light-emitting member 20 can also be the three optical coupler LED members 32, and each light coupler member 22, 23, 24 of the light-emitting member 20 are also in parallel connection to each drive activating connecting pins (shown in FIG. 2) of the driver processor (IC component) 21, to enable simultaneous drive activation by the driver processor (IC component) 21 with the light-emitting member carrier 3 when the switch member 4 is pressed to select light-emitting color modules, so the operator can directly get the desired light colors produced by the module from the end face of the casing unit 1.

FIGS. 1 and 2 illustrate how the preferred embodiment of the invention is assembled and operating to emit light. The device has at least a light-emitting member carrier 3 of three light coupler type LED member 32, fixed at a specified position, serving to emit light for alarm or decorative purposes. This light-emitting member carrier 3 is electrically connected by a conductive wire 33 to the driver circuit 2 inside the casing unit 1. This casing unit 1 can be fastened at a position for convenient operation, so that the user can conveniently press on the switch member 4 on the end face of the casing unit 1, to choose the desired light-emitting member carrier 3, to have the light colors emitted from the three light coupler type LED member 32. When pressed, this switch member 4 will create a voltage signal to activate the driver processor (IC component) 21 in the driver circuit 2, to drive the driver module by pressing the switch member 3, until after the selection when the voltage signals of the switch member 4 are fixed, to drive the driver processor (IC component) 21 under the module; under each specified drive module, the driver processor (IC component) 21 will produce electrical signals to activate the light colors, red (R), green (G), blue (B) of the light coupler members 34, 35 36, of the three light coupler type LED member 32, from each correspondingly specified driver connector pin of the driver module, besides selection of specified driver module option by independently activating a light coupler member 34, 35 or 36, to respectively display a light color of red (R), green (G) or blue (B), it will simultaneously activate two or more light coupler members 34, 35 or 34, 36, or 35, 36, or simultaneously all to emit light. The light coupler members 34, 35, 36 emit light colors and light waves for natural blending, creating different colors emission, in the embodiment of the invention, we can have at least seven different colors of light, to obtain consumer's spontaneous touch-control effects by activating the light-emitting members to create changing colors. When the switch member 4 is pressed to perform driver module selection, the desired light color will drive and activate the driver circuit 2 for connection according to selected module, from the driver connector pin of the driver processor (IC component) 21, to serving as light-emitting member 20 for selection of light color display, creating same selection of light color display, so the operator can directly select the module and get the desired light color created by the selected module from the end face of the casing unit 1.

Each three light coupler type LED member 32 on the light-emitting member carrier 3 in the same set, or each three light coupler type LED member 32 in a different set of light-emitting member carrier 3, can respectively perform control by connecting one set or more sets of driver circuits 2, this one or more set of driver circuit 2 can be installed in a same or different casing unit 1 for operation and use.

Of course, the driver circuit 2 may be installed with the prior art of regular remote-control circuit, to become a remote control operation, but not limited thereto, therefore, all modifications or variations made without departing from the spirit of the invention shall be included in the subject claim.

What is claimed is:

1. A drive control device for mixing and changing of light colors of light-emitting member, comprising:
a casing unit, its inside providing an accommodating space to install at least one set of driver circuit, at an end face of the casing unit being at least one opening, to accommodate the installation of a switch member;
at least one set of light-emitting member carrier, on an end face of the carrier being installed at least one light-emitting member, electrically connected to the driver circuit;
at least one set of driver circuit, the electrically connected driver processor (IC component) of the power supply may select a light color driver module by operating the switch member, for respective activation of all light coupler member of the light-emitting member according to specified module;
by means of various driver module settings of the programmed driver processor (IC component), one can optionally activate the color of light coupler member in the light-emitting member, to activate emission of light independently or simultaneously by two or more members, the light being naturally blended in optical wave spectrum to create different colors of light emission, to enable consumer's spontaneous drive-control effects for driving the light-emitting member to produce color changes.

2. The drive control device for mixing and changing of light colors of light-emitting member of claim 1, wherein said casing unit consists of two pairs of hemispheric plates that is opposite to and fastened to each other, which can be used in various shapes and specifications.

3. The drive control device for mixing and changing of light colors of light-emitting member of claim 2, wherein end faces of the casing unit have openings, to assemble light-emitting members installed in the driver circuit for optional light color display, to get acknowledgement and verification of selected light colors when pressing the optional switches.

4. The drive control device for mixing and changing of light colors of light-emitting member of claim 1, wherein there is at least one light-emitting member installed on the light-emitting member carrier, using an LED member of non-single light coupler member.

5. The drive control device for mixing and changing of light colors of light-emitting member of claim 4, wherein said light-emitting member is preferably a three light coupler type LED member consisting of light coupler members of three different light colors, red (R), green (G) and blue (B).

6. The drive control device for mixing and changing of light colors of light-emitting member of claim 1, wherein each light coupler member of the light-emitting member of the driver processor (IC component) may be respectively set by activating light-emitting assembly module, may be written by program design to set various driver modules for use.

7. The drive control device for mixing and changing of light colors of light-emitting member of claim 6, wherein the driver module setting of the driver processor (IC component) in the driver circuit can adopt directly the operation originally designed by the processor (IC component) to set various driver modules.

8. The drive control device for mixing and changing of light colors of light-emitting member of claim 1, wherein in the driver circuit may be installed a light-emitting member for optional light color display, optional operation by pressing the switch member, for simultaneous activation and operation of the driver processor (IC component) and the light-emitting member of the light-emitting member carrier, so the operator can directly select the module, and directly get from the end face of the casing unit the light colors created by the light-emitting member of the light-emitting member carrier and the selected module.

9. The drive control device for mixing and changing of light colors of light-emitting member of claim 8, wherein the light-emitting member of the driver circuit for optional light color display is an LED member of non-single light coupler member.

10. The drive control device for mixing and changing of light colors of light-emitting member of claim 9, wherein said light-emitting member is preferably a three light coupler type Led member consisting of three different light color light coupler members, red (R), green (G) and blue (B).

11. The drive control device for mixing and changing of light colors of light-emitting member of claim 1, wherein the three light coupler type LED member in the same set of light-emitting member carrier, or the three light coupler type Led member in a different set of light-emitting member carrier can be connected and controlled by a same set of driver circuit.

12. The drive control device for mixing and changing of light colors of light-emitting member of claim 11, wherein said the three light coupler type LED member in the same set of light-emitting member carrier, or the three light coupler type LED member in a different set of light-emitting member carrier can be connected and controlled by a different set of driver circuit.

13. The drive control device for mixing and changing of light colors of light-emitting member of claim 1, wherein said driver circuit may be assembled with a remote control circuit to operate optional light-emitting module by remote control.
